(19) United States
(12) Patent Application Publication
(10) Pub. No.: US 2026/0042941 A1
(43) Pub. Date: Feb. 12, 2026

(54) WATER-RESISTANT ADHESIVE

(71) Applicant: Danmarks Tekniske Universitet, Kongens Lyngby (DK)

(72) Inventors: Saeed Zajforoushan Moghaddam, Kongens Lyngby (DK); Esben Thormann, Kongens Lyngby (DK); Runtian Qie, Kongens Lyngby (DK)

(21) Appl. No.: 19/100,370

(22) PCT Filed: Aug. 9, 2023
(86) PCT No.: PCT/EP2023/072001

§ 371 Date: Jan. 31, 2025

(30) Foreign Application Priority Data
Aug. 10, 2022 (EP) 22189669.9

(51) Int. Cl. C09J 105/08; C08K 5/107; C09J 11/06

(52) U.S. Cl. CPC C09J 105/08; C09J 11/06; C08K 5/107

(57) ABSTRACT

A method for preparing an adhesive, said method comprising—mixing chitosan and tannic acid in an aqueous solution, and adjusting the pH value of the resulting mixture to a pH that induces the formation of a polymer-rich phase and a polymer-poor phase, preferably in a pH range of from 4.5 to 6, such as from 5 to 5.5 to obtain a polymer-rich phase and a polymer-poor phase; and—isolating the polymer-rich phase to obtain said adhesive. Described is also an adhesive obtainable from said method and uses thereof.

### FIELD OF THE INVENTION

The field of the invention is provision of adhesives based on biomolecules.

### BACKGROUND OF THE INVENTION

It is a growing desire to provide 100% biodegradable products for chemicals used in different industries. Biopolymers have received considerable attention in recent years given the environmental concern related to the incorrect disposal of materials based on synthetic plastics. This is also true in the field of adhesives, where renewable materials from biopolymers to monomers derived from renewable resources are increasingly investigated.

The sustainability of biomolecules-based (bio-based) products is, however, not a sufficient argument for their commercialisation. For example, the bio-based adhesives should perform at least comparably to commercial counterparts, which is a challenging benchmark.

In this context, poor water-resistance is a critical shortcoming of bio-based adhesives that makes them unfavorable for outdoor applications. Water penetration within the bio-based adhesives produces swelling, plasticization, and leaching of the adhesive joint, all of which can cause a cohesive failure. Aside from cohesive weakening, the adhesive-substrate interfacial adhesion is also diminished in wet conditions.

JP2003221571 relates to a water-based adhesive composed of chitosan and tannic acid. The adhesive is in the form of a solution e.g., chitosan and tannic acid dissolved in acetic acid. Chitosan, which is an essential component of the adhesive composition of JP2003221571, is deacetylated to a deacetylation degree of 80-90% by heating chitin which constitutes arthropod skin, mollusc shell, fungal cell wall with concentrated alkaline solution or by potash melting. The weight ratio between tannic acid and chitosan is given as 0.3-4 tannic acid to 1 chitosan. Chitosan and tannic acid are present in an acidic aqueous solution, preferably containing acetic acid, and the solution has a pH of about 2.5.

### SUMMARY OF THE INVENTION

The problem underlying the invention is the fact that bio-based adhesives, in general, cannot perform as well as the synthetic ones. A major issue with bio-based adhesives is their poor water-resistance. This means the adhesive, when exposed to humidity or liquid water, becomes significantly weaker and often falls apart. Thus, bio-based adhesives in general are not suitable for outdoor (exterior) applications.

The problem underlying the invention is to provide new compositions based on the biomolecules, that can be used as an adhesive with improved properties comprising chitosan and tannic acid.

The problem of the invention has been solved by the subject-matter as defined in the independent claims.

The invention provides a bio-based adhesive obtainable by mixing the tannic acid and the chitosan in a solution having a pH-value that allows the creation of two phases (coacervation), namely a polymer-rich (water-poor phase) phase and a polymer-poor phase (water-rich phase) and isolating the polymer-rich phase. The obtained polymer-rich phase contains a complex of chitosan and tannic acid with strong cohesive interactions and cross-linking.

Accordingly, the present invention provides a method for preparing an adhesive, said method comprising
mixing chitosan and tannic acid in an aqueous solution, and adjusting the pH value of the resulting mixture to a pH that induces the formation of a polymer-rich phase and a polymer-poor phase to obtain a polymer-rich phase and a polymer-poor phase; and
isolating the polymer-rich phase to obtain said adhesive.

Preferably the pH is in a pH range of 4.2-6, more preferably in a pH range of from 4.5 to 6, such as from 5 to 5.5.

Said isolation step may comprise a step of centrifugation, filtration, sedimentation, decantation, or flocculation or any combination thereof. In addition, the mixing of chitosan and tannic acid in an aqueous solution may comprise mixing a solution of tannic acid and/or solid tannic acid with a solution of chitosan.

The present invention also relates to an adhesive obtainable from said method.

Thus, the present invention also provides an adhesive obtainable by
mixing chitosan and tannic acid in an aqueous solution at the pH value in a range of from 4.5 to 6 preferably at about 5.5,
centrifuging the mixture to obtain a polymer-rich and a polymer-poor phase,
isolating the polymer-rich phase.

Alternatively, to centrifuging the mixture it is possible to vacuum filter the mixture to obtain the polymer-rich phase. As mentioned above, other methods may also be used such as sedimentation, decantation or flocculation or any combination thereof.

Moreover, the present invention provides a method for preparing an adhesive characterized by
mixing a chitosan solution, wherein pH was adjusted to a pH in a range of from 4.5 to 6 with a solution of the tannic acid to obtain a mixture, and centrifuging the mixture to obtain a polymer-rich phase and the polymer-poor phase; and isolating the polymer-rich phase.

In embodiments, chitosan is first dissolved in 1% acetic acid (pH 2.5) and pH is then adjusted to 4.5 to 6 such as from 3.5 to 5.5 and then a solution of tannic acid is added.

In embodiments, a method for preparing an adhesive characterized by
mixing a chitosan solution with a solution of the tannic acid and adjusting pH to a pH in a range of from 4.5 to 6, and centrifuging the mixture to obtain a polymer-rich phase and the polymer-poor phase; and isolating the polymer-rich phase.

The present invention also relates to an adhesive containing cross-linked chitosan and tannic acid, characterized by wet Lap shear strength of at least 3.5 MPa during a time period of at least 30 days such as 30 days or 60 days, wherein the Lap shear strength is measured using a Universal Testing System with Intron 345c, USA. The dry lap shear strength is about 4 MPa. If an adhesive is not water-resistant the wet strength values would continuously decrease to values close to zero (as a function of exposure time to water). The fact that for an adhesive of the present invention, wet strength is reduced very little compared to dry strength, means it is a highly water-resistant adhesive. This is a unique property, as bio-based adhesives are generally very poorly water resistant.

Moreover, the present invention relates to an adhesive additive obtainable by
mixing chitosan and tannic acid in a weight ratio in an aqueous solution at the pH value in a range of from 4.5 to 6 preferably at about 5.5,
centrifuging the mixture to obtain a polymer-rich and a polymer-poor phase,
isolating the polymer-rich phase, and
lyophilizing the polymer-rich phase.

In embodiment, an adhesive additive is obtainable by
dissolving chitosan in 1% acetic acid
adjusting the pH of the chitosan solution to 3.5 to 5.5
adding the solution of the tannic acid
centrifuging the mixture to obtain a polymer-rich and a polymer-poor phase,
isolating the polymer-rich phase and
lyophilizing the polymer-rich phase.

### DESCRIPTION OF THE FIGURES

FIG. 1 shows Lap shear strength of chitosan-tannic acid complex/coacervate adhesive in dry state; effect of chitosan:tannic acid weight ratio.

FIG. 2 shows Lap shear strength of chitosan-tannic acid complex/coacervate adhesive in wet state (after one day immersion in water); effect of chitosan:tannic acid weight ratio.

FIG. 3 shows results of test of water-resistance of chitosan-tannic acid complex/coacervate adhesive (1:0.5 chitosan:tannic acid weight ratio).

FIG. 4 shows results of test of water-resistance of Gorilla Glue (commercial water-proof adhesive).

FIG. 5 shows results of test of water-resistance of SuperGlue (commercial water-resistant adhesive).

FIG. 6 shows results of durability of adhesives tested by cyclic test.

FIG. 7 shows an adhesive made by mixing the lyophilized chitosan-tannic acid (1:0.5 chitosan:tannic acid weight ratio) powder with water (1:4 weight ratio), dry and wet lap shear strength (one-day immersion) measured.

FIG. 8 shows TGA of lyophilized chitosan-tannic acid powder (1:0.5 chitosan:tannic acid weight ratio) together with pure chitosan and tannic acid.

FIG. 9 shows FTIR of lyophilized chitosan-tannic acid powder (1:0.5 chitosan:tannic acid weight ratio) together with pure chitosan and tannic acid.

FIG. 10 shows the process of mixing chitosan and tannic acid solutions (1:0.5 chitosan:tannic acid weight ratio) at different pH values.

FIG. 11 shows the precipitated chitosan-tannic acid complex/coacervate (after centrifugation) from different chitosan:tannic acid weight ratios.

FIG. 12 shows underwater durability of chitosan-tannic acid adhesive (1:0.5 chitosan:tannic acid weight ratio) and two commercial adhesives over extended periods, each in triplicates.

FIG. 13 shows lap shear strength of the chitosan-tannic acid adhesive (1:0.5 chitosan:tannic acid weight ratio) measured on different substrates.

FIG. 14 shows shear strength of the chitosan-tannic acid adhesive (1:0.5 chitosan:tannic acid weight ratio) measured on plywood substrates, where the adhesive was cured at 70° C. for 2 hrs (standard conditions) or 150° C. for 10 min.

### DETAILED DESCRIPTION OF THE INVENTION

Adhesives are man-made products that are used in almost any industry. Despite their favourable functionality, most commercial adhesives are petroleum-based (synthetic polymers) and contain harmful volatile substances e.g., formaldehyde. To reduce the health and environmental footprints of these adhesives, research is dedicated to developing novel adhesives that are made from natural, bio-based materials, such as proteins, polysaccharides, and plant phenolics. The issue is that bio-based adhesives, in general, cannot perform as well as the synthetic ones. A major issue with bio-based adhesives is their poor water-resistance. This means the adhesive, when exposed to humidity or liquid water, becomes significantly weaker and often falls apart. Thus, bio-based adhesives in general are not suitable for outdoor (exterior) applications. This shortcoming significantly hampers the widespread use of bio-based adhesive.

The present invention addresses this problem and relates to a method of obtaining a fully bio-based adhesive with commercial-level water-resistance. The adhesive contains two components. A polysaccharide component (chitosan e.g., derived from crustaceans such as, e.g., shrimp shell, or mushrooms) and a plant phenolic component (tannic acid e.g., from specific trees). The two components are mixed under optimized conditions (e.g., pH of the solution, ratio of chitosan and tannic acid) so they undergo complexation/coacervation or cross-linking. This means that by mixing aqueous solutions of chitosan and tannic acid it is possible to obtain a precipitated material, that can be used as an adhesive.

Thus, in a first aspect, the present invention relates to an adhesive obtainable by
Mixing chitosan and tannic acid in a given weight ratio in an aqueous solution at the pH value in a range of from 4.5 to 6 preferably at about 5.5,
centrifuging the mixture to obtain a polymer-rich and a polymer-poor phase,
Isolating the polymer-rich phase.

In a further aspect the present invention provides a method for preparing an adhesive, said method comprising
mixing chitosan and tannic acid in an aqueous solution, and adjusting the pH value of the resulting mixture to a pH that induces the formation of a polymer-rich phase and a polymer-poor phase, preferably in a pH range of from 4.5 to 6, such as from 5 to 5.5 to obtain a polymer-rich phase and a polymer-poor phase; and
isolating the polymer-rich phase to obtain said adhesive.

Said isolation step may comprise a step of centrifugation, filtration, sedimentation, decantation, or flocculation any or combination thereof. Additional suitable methods that allow for isolation of the polymer-rich phase will be evident to the skilled person. The mixing chitosan and tannic acid in an aqueous solution may comprise mixing a solution of tannic acid and/or solid tannic acid with a solution of chitosan.

The present invention also relates to an adhesive obtainable from said method. As is shown in the examples, the pH range of about 4.5-6 was where the chitosan-tannic acid mixture underwent phase separation and became turbid/cloudy, after which a precipitated polymer-rich material was obtainable from the mixture by separation of the two phases. The degree of turbidity and amount of the complexed chitosan and tannic acid in the polymer-rich phase varied with pH, and the highest amount of turbidity and complexed chitosan-tannic acid in the polymer-rich phase was found at a pH of about pH 5.5. However, the optimal pH for providing the polymer-rich phase may depend on the grade or molecular weight of the chitosan used. The examples herein and the present specification give guidance of how to find the optimal pH.

Chitosan is a linear polysaccharide composed of randomly distributed β-(1→4)-linked D-glucosamine (deacetylated unit) and N-acetyl-D-glucosamine (acetylated unit). It is made by treating the chitin from shrimp and other crustaceans with an alkaline solution, such as sodium hydroxide.

Chitosan may be obtained from chitin by chemical or enzymatic methods. In chemical methods, both acidic and alkaline extraction can be used, but the alkaline method is used more frequently.

Chitosan is produced commercially by deacetylation of chitin, which is the structural element in the exoskeleton of crustaceans (such as crabs and shrimp) and cell walls of fungi. The degree of deacetylation (% DD) can be determined by NMR spectroscopy, and the % DD in commercial chitosan ranges from 60 to 100%. For commercially produced chitosan, the viscosity range (1 wt. % in 1% acetic acid at 25° C.) is generally 5-5000 cps, corresponding to an average MW of 20,000-2,000,000 Daltons.

A common method for obtaining chitosan is the deacetylation of chitin using sodium hydroxide in excess as a reagent and water as a solvent. The reaction follows first-order kinetics though it occurs in two steps; the activation energy barrier for the first stage is estimated at 48.8 KJ·mol⁻¹ at 25-120° C. and is higher than the barrier to the second stage.

The amino group in chitosan has a pKₐ value of ˜6.5, which leads to some protonation in neutral solution, increasing with increased acidity (decreased pH) and the % DD-value. This makes chitosan water-soluble and a bioadhesive which readily binds to negatively charged surfaces such as mucosal membranes. The free amine groups on chitosan chains can make crosslinked polymeric networks with dicarboxylic acids to improve chitosan's mechanical properties. Some chitosan grades may have been obtained by chemical modifications so that they are more soluble in neutral pH.

Chitosan suitable for use in an adhesive according to the invention has a degree of deacetylation corresponding to the degree of deacetylation of commercially available chitosan. In embodiments the chitosan has a degree of deacetylation of 90% or more such as 91% or more, 92% or more, about 92.6% or more, 93% or more, 94% or more, 95% or more, or 97% or more.

Typically, the molecular weight of a chitosan suitable for use in an adhesive of the invention is in a range from 150,000 to 750,000 Daltons such as from 175,000 to 500,000 Daltons, from 200,000 to 400,000 Daltons, from 200,000 to 300,000 such as about 250,000 Daltons. The viscosity is in a range of from 50 to 300 cps such as from 75 to 200 cps, from 75 to 150 cps such as about 100 cps.

Chitosan is soluble in dilute organic acid solutions but is insoluble in high concentrations of hydrogen ions and is precipitated as a gel-like compound. Chitosan is positively charged by amine groups, making it suitable for binding to negatively charged molecules. However, it has disadvantages such as low mechanical strength and low-temperature response rate; it must be combined with other gelling agents to improve its properties.

Tannic acid is a specific form of tannin, a type of polyphenol. Its weak acidity (pKₐ about 6) is due to the numerous phenol groups in the structure. The chemical formula for commercial tannic acid is often given as C₇₆H₅₂O₄₆, which corresponds with decagalloyl glucose, but in fact, it is a mixture of polygalloyl glucoses or polygalloyl quinic acid esters with the number of galloyl moieties per molecule ranging from 2 up to 12 depending on the plant source used to extract the tannic acid. Commercial tannic acid is usually extracted from any of the following plant parts: Tara pods (Caesalpinia spinosa), gallnuts from Rus semialata or Quercus infectoria or Sicilian sumac leaves (Rhus coriaria).

According to the definitions provided in external references such as international pharmacopoeia, Food Chemical codex and FAO-WHO tannic acid monograph only tannins obtained from the above-mentioned plants can be considered tannic acid. Sometimes extracts from chestnut or oak wood are also described as tannic acid but this is an incorrect use of the term. It is a yellow to light brown amorphous powder.

While tannic acid is a specific type of tannin (plant polyphenol), the two terms are sometimes (incorrectly) used interchangeably. The long-standing misuse of the terms, and its inclusion in scholarly articles has compounded the confusion. This is particularly widespread in relation to green tea and black tea, both of which contain tannin but not tannic acid.

Tannic acid is soluble in water (250 g/L), in ethanol (100 g/L).

The tannic acid used in the Examples herein is obtained from Sigma-Aldrich (W304204, CAS No. 1401-55-4) with a molecular weight of 1701.20. It is a light beige to dark beige to dark brown powder.

In the method for obtaining an adhesive, the chitosan may be dissolved in water and then the pH may be adjusted to a pH in the range of 4.5 to 6. Because chitosan in general is very difficult to dissolve in pH 4.5-6, the common approach is to first dissolve it in 1-2% acetic acid, and after dissolution, pH is adjusted to 4.5-6. Herein, partial precipitation generally occurs, but with time this can re-dissolve. Depending on the type of chitosan, one may be able to avoid the dissolution-in-acetic acid step, and add chitosan to water, and adjust the solution to pH to 4.5-6 afterwards or immediately dissolve chitosan in the solution/buffer with pH of 4.5-6. Furthermore, it is possible to use chitosan derivatives such as chitosan hydrochloride, carboxymethyl chitosan, chitosan acetate, etc. which are much easier to dissolve in water. For example, when chitosan hydrochloride is used it dissolves immediately in water and reduces the pH value of the solution, so there is no need for initial dissolution in acetic acid.

Alternatively, the chitosan may be dissolved in an aqueous solution having a pH in the range of 4.5 to 6. The aqueous solution may be a suitable buffer solution such as an acetic acid/acetate buffer solution.

To this solution, tannic acid may be added. Alternatively, tannic acid may be dissolved in water or in a suitable buffer such as an acetic acid/acetate buffer solution and then added to the chitosan solution. The reverse order may also be applicable, i.e., to add chitosan or a chitosan solution to a solution of tannic acid.

Even if both chitosan and tannic acid are soluble in aqueous media, some reaction takes place between chitosan and tannic acid when brought into contact in the aqueous medium. It is contemplated that complexation or coacervation takes place leading to a so-called “coacervate” polymer-rich phase, alternatively also described in literature as liquid-liquid phase separation (LLPS), or a general phase separation of a molecular complex, so the aqueous medium containing chitosan and tannic acid becomes opaque/turbid, and a precipitation of chitosan-tannic acid coacervate/complex takes place. In the present context, the terms “complex”, “cross-linked product”, “precipitate” and “coacervate” is used for the product obtained when contacting chitosan and tannic acid in an aqueous medium having a pH of from 4.5 to 6.

In general, precipitation is considered the process of solute molecules coming out of a solution to form solid particles due to a change in conditions like e.g., pH or concentration. Coacervation, generally, involves the separation of a solution into two liquid phases resulting from specific molecular interactions, resulting in a coacervate phase rich in solutes i.e., in the present case a polymer-rich phase, comprising most of the chitosan-tannic acid. Generally, precipitation forms solid particles, while coacervation creates liquid droplets. Precipitation generally occurs when solubility limits are exceeded, while coacervation arises from phase separation driven by molecular interactions.

Accordingly, the phase separation occurring upon mixing of tannic acid and chitosan may be investigated to evaluate if the produced complex has a precipitation or a coacervated nature. Formation of a coacervate may be investigated in a number of ways known to the skilled person such as for example by visual observation, light microscopy, behavioral assessments (such as e.g., dilution of the polymer-rich phase) and/or rheological measurements. In example, microscopic inspection using a light microscope, such as e.g., using a light microscope at e.g., 20×-1000×magnification, of the mixture can be used to determine the nature of the produced product, where coacervation generally results in the formation of dynamic oil-like droplets, while precipitation generally leads for formation of solid particles, wherein both states are generally visible when performing e.g., light microscopy.

In the present invention, a pH that induces the formation of a polymer-rich phase and a polymer-poor phase is to be understood as a pH where the solution changes from a clear solution to an opaque solution containing at least two phases e.g., a polymer-rich and a polymer poor phase. Such transition may be investigated in a plethora of ways known to the skilled person, such as by visual inspection, UV-vis absorbance and/or centrifugation and inspection of the pelleted fraction. If necessary, pH of the final mixture containing both chitosan and tannic acid may be adjusted to a pH from 4.5 to 6.

The concentration of chitosan in the mixture obtained is up to 80 mg/mL such as from 1 mg/mL to 75 mg/mL, from 2 mg/mL to 70 mg/mL, from 3 mg/mL to 60 mg/ml, from 3 mg/mL to 50 mg/mL, from 4 mg/mL to 40 mg/mL, from 4 mg/mL to 30 mg/mL, from 5 mg/mL to 20 mg/mL from 5 mg/ml to 15 mg/mL, from 6 mg/mL to 10 mg/mL or about 5 mg/mL, 6 mg/mL, 7 mg/ml, 8 mg/mL, 9 mg/mL or 10 mg/mL before centrifugation and isolation of the polymer-rich fraction.

The concentration of tannic acid in the mixture obtained is up to 80 mg/ml such as from 1 mg/ml to 75 mg/mL, from 2 mg/mL to 70 mg/mL, from 3 mg/mL to 60 mg/ml, from 3 mg/mL to 50 mg/mL, from 4 mg/mL to 40 mg/mL, from 4 mg/mL to 30 mg/mL, from 5 mg/mL to 20 mg/mL from 5 mg/ml to 15 mg/mL, from 6 mg/mL to 10 mg/mL or about 5 mg/mL, 6 mg/mL, 7 mg/ml, 8 mg/mL, 9 mg/mL or 10 mg/mL before centrifugation and isolation of the polymer-rich fraction.

In the mixture, the weight ratio of chitosan:tannic acid is in a ratio of from 1:0.1 to 1:10 such as from 1:0.2 to 1:5, from 1:0.25 to 1:5, preferably from 1:0.25 to 1:1, such as 1:0.25, 1:0.3, 1:0.4, 1:0.5, 1:0.6, 1:0.7, 1:0,8, 1:0.9, 1:1.

In embodiments, the pH of the solution(s) or mixture is about 5.5.

The polymer-rich phase is isolated and used as such or it may be dried for later use upon addition of water. The polymer-rich phase may also be lyophilized to obtain a solid powder, which can be mixed with water or a suitable buffer. Said solid powder is useful to enhance the storage and transportation properties of the adhesive.

For some purposes, it is useful to keep the adhesive of the invention in a solid form. For that purpose, the above-obtained gel can be lyophilized to obtain white powder which can be incorporated into various adhesive compositions and mixed with water or buffer and other possible ingredients to obtain the adhesive of the present invention.

Thus, the adhesive may also be obtainable by further steps of
lyophilizing the precipitated phase to obtain solid material; and
mixing the so obtained solid material with water or a buffer with a pH-value of from about 4.5 to about 6.

The precipitated material from the polymer-rich phase has the following properties:
it is like a gel (contains water, not a dry solid material)
It has a white-milky color
It is opaque.

The physical properties of the precipitated chitosan:tannic acid was found to be highly dependent on the chitosan:tannic acid ratio (as shown in FIG. 11). The 1:0.5 ratio was found to have a soft homogenous gel-like material, optimal for the applications as an adhesive, which e.g., needs to be applied to surfaces. As shown in FIG. 11, increasing the amount of tannic acid (for example chitosan:tannic acid ratio 1:10) the resulting material was harder and more granular, which was less favored for the application as an adhesive.

The adhesive of the present invention may be characterized by Lap shear strength. Thus, the wet lap shear strength should be at least 3 MPa during a time period of at least 30 days, wherein the Lap shear strength is measured using a Universal Testing System. Moreover, the adhesive is evenly applied to pre-cut aluminum substrates (50 mm×12 mm), cured in an oven at 70° C. for 2 hour and tested according to a modified ASTM D1002 procedure.

The adhesive of the present invention can be cured at a temperature of from 50 to 90° C. such as at a temperature of from 60 to 80° C., from 65 to 75° C. or about 70° C. for a time period of from 0.5 to 6 hours such as from 0.5 to 4 hours, from 0.5 to 3 hours, from 0.75 to 3 hours, from 0.75 to 2 hours, from 0.75 to 1.5 hours, or about 1 hour. The curing can be done at various conditions. For example, the initial curing temperature can be preferably about 70° C. to avoid fast evaporation of water which can leave bubbles in the dried adhesive. The formation of bubbles would lead to a weak mechanical strength. The curing at 70° C. for about 1 to 2 hours is preferred.

However, it is also possible to start the curing at a lower temperature to gradually remove the water from the adhesive, but then when the solvent has evaporated perform the post-curing at much higher temperatures of about 100-200° C. to further cross-link the product and possibly improve the mechanical strength and water-resistance.

Additionally, curing at higher temperatures but with a shorter time interval may also be preferred for specific applications. Considering that, the adhesive of the present invention can be cured at a temperature of from 130 to 170° C. such as at a temperature of from 140 to 160° C., from 145 to 155° C. or about 150° C. for a time period of from 1 to 20 minutes, such as from 5 to 15 minutes, from 6 to 14 minutes, from 7 to 13 minutes, from 8 to 12 minutes, from 9 to 11 minutes, or about 10 minutes. For some applications the curing at 150° C. for about 5-15 minutes, such as 10 minutes is preferred. Examples of such applications are e.g., the application of the adhesive of the present invention in adhesion of plywood substrates. The variations with regard to temperatures, procedures, and durations, can vary very much depending on application.

The present invention also relates to an adhesive containing cross-linked chitosan and tannic acid, characterized by wet lap shear strength of at least 3.5 MPa during a time period of at least 30 days, wherein the wet lap shear strength is measured using a Universal Testing System, intron 345c, USA.

Substrates may e.g., be aluminum, poly (methyl methacrylate) (Acrylic), poly (carbonate) (PC), steel and/or plywood. The shear strength also depend on the combination of the materials to be bound together, e.g., aluminum binding to poly (methyl methacrylate), aluminum binding to poly (carbonate) (PC), aluminum binding to steel, aluminum binding to plywood, or plywood binding to plywood, or any alternative combination of the aforementioned. Further suitable substrates and combinations thereof to be adhered will be evident to the skilled person.

The surface of the substrate(s) to be joined also greatly influences the measured shear strength(s). Substrates such as e.g., plastics which are generally surface treated (using adhesion primers, plasma, etc.) to improve the adhesion strength, which are joined by an adhesive according to the present invention, are expected to have a higher shear strength, such as a lap shear strength of more than 2 MPa, compared to a substrate with a low surface energy/non-reactive nature.

On the other hand, substrates with a low surface energy/non-reactive nature e.g., poly (methyl methacrylate) (Acryl), joined by an adhesive according to the present invention are to be expected to have a lesser shear strength, such as a lap shear strength below 2 MPa, compared to substrates where the surface is treated to improve the adhesion strength.

Accordingly, an adhesive containing cross-linked chitosan and tannic acid of the present invention, may also be characterized by a dry Lap shear strength of
at least 3.5 MPa on aluminum/stainless steel substrates,
at least 2 MPa on aluminum/plywood substrates, and/or
at least 4.5 MPa on plywood/plywood substrates,
   wherein the Lap shear strength is measured using a Universal Testing System. The present invention also relates to a gel consisting of cross-linked chitosan and tannic acid, wherein chitosan and tannic acid is present in the gel in a total concentration of from 2 to 10 wt % such as from 3 to 8 wt %, from 4 to 6 wt % such as about 5 wt %. Such a gel can be used as an adhesive.

Provided is also an adhesive additive obtainable by
Mixing chitosan and tannic acid (wt % ratio) in an aqueous solution at the pH value in a range of from 4.5 to 6 preferably at about 5.5,
centrifuging or filtering the mixture to obtain a polymer-rich and a polymer-poor phase;
Isolating the polymer-rich phase, and
lyophilizing the polymer-rich phase.

In embodiments, an adhesive additive is obtainable by
dissolving chitosan in 1% acetic acid
adjusting the pH of the chitosan solution to 3.5 to 5.5
adding the solution of the tannic acid
centrifuging or filtering the mixture to obtain a polymer-rich and a polymer-poor phase,
isolating the polymer-rich phase.
lyophilizing the polymer-rich phase.

Such an addition adhesive can be used as additives in other adhesives to improve water-resistance, to modify properties and/or to increase the bio-based content while providing mechanical strength and water-resistance.

The following figures and examples are provided below to illustrate the present invention. They are intended to be illustrative and are not to be construed as limiting in any way.

### Experimental

Materials used in the examples are tannic acid (Mw=1701.2, ACS reagent), sodium chloride, and sodium hydroxide (≥97%) purchased from Sigma-Aldrich. Hydrochloric acid (37%) and acetic acid (≥99.7%) were purchased from Fisher Scientific. Chitosan (degree of deacetylation >92.6%, viscosity of 1% solution in 1% acetic acid at 20° C.=71-150 mPas) was purchased from Heppe Medical Chitosan GmbH. Purified water with a resistivity of 18.2 MΩ cm was used for all solutions. The pH of the solutions was adjusted using 1 M hydrochloric acid and 1 M sodium hydroxide.

According to the invention, acidic solutions of chitosan at pH 5.5 were mixed with tannic acid. pH 5.5 was found to be the optimal condition for the preparation of chitosan-tannic acid adhesive.

The ratio between chitosan vs. tannic acid of 1:0.25 and 1:0.5 showed the maximal dry shear strength.

The chitosan used in the present invention was a commercial product with a degree of deacetylation >92.6%, viscosity of 1% solution in 1% acetic acid at 20° C.=71-150 mPas.

### Example 1

### Preparation of an Adhesive of the Present Invention

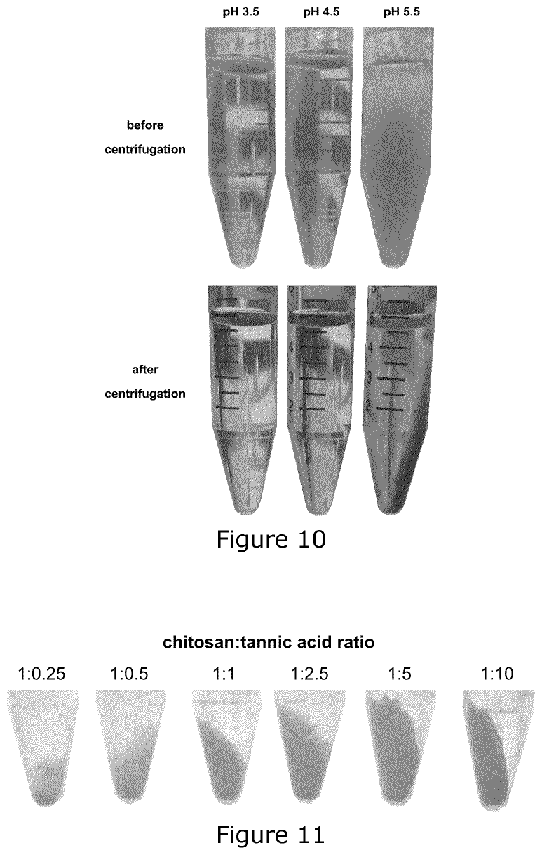

Chitosan was first dissolved in 1 v/v % acetic acid to obtain a 10 mg/ml solution. After complete dissolution, the pH of the solution was adjusted to 5.5, followed by stirring for redissolving the partially precipitated content. Tannic acid (10, 20, 40, 100, 200, and 400 mg/mL) was dissolved in water without pH adjustment. The complex, coacervate of chitosan-tannic acid in each case was obtained by mixing 4:1 volume ration of the chitosan solution and the tannic acid solution (e.g. 4 mL chitosan solution with 1 mL tannic acid aqueous solution), followed by centrifugation for 10 min at 5000 rpm. A two-phase system having a water-rich phase on top and a polymer-rich phase precipitated on the bottom was obtained. It was shown that adjustment of the pH highly influenced the formation of chitosan-tannic acid precipitate (FIG. 10). Only minor precipitate was formed at pH 3.5 and pH 4.5, while pH 5.5 was the optimal condition for preparation of chitosan-tannic acid precipitate (complex/coacervate) where maximum cloudiness (before centrifugation) and precipitate (after centrifugation) was observed (FIG. 10).

The polymer-rich phase (complexed/coacervated phase) was isolated e.g., by centrifugation, to obtain the adhesive according to the present invention.

The ratio between the two components affects the amount and the physical properties of the chitosan-tannic acid precipitate and it was found that that the collected precipitate transforms from a soft gel-like material into a more solid-like material when increasing the amount of tannic acid relative to chitosan (FIG. 11).

The adhesive of the present invention has gel-like properties.

The wt. % ratio of chitosan vs. tannic acid was 1:0.25 to 1:10. The maximal dry shear strength was obtained with the wt. % of 1:0.25-1:0.5.

For some purposes, it be useful to keep the adhesive of the invention in a solid form. For that purposes the above-obtained gel can be lyophilized to obtain white powder which can be mixed with water in a desired ratio to obtain the adhesive of the present invention.

### Adhesive Testing:

Lap shear strength (single-lap mode) of the adhesives was measured using a Universal Testing System (Instron 345c, USA). Pre-cut aluminum substrates (50 mm×12 mm) were polished, degreased, and rinsed with demineralized water, ethanol, and acetone. The complex coacervate was evenly applied, clamped, and cured in the oven at 70° C. for 2 h. The samples were cooled down to room temperature for at least 1 hr, then tested according to a modified ASTM D1002 procedure (cross-head speed 1.5 mm/min, overlap area 12 mm×12 mm). Two commercial adhesives, i.e., Loctite Superglue Control and Original Gorilla glue, were tested as commercial controls. These adhesives were applied and cured according to the instructions provided by the supplier (24 hr. curing for both cases, ambient humidity of ˜50%). Five replicas (n=5) were tested for each sample.

Water-resistance of the adhesives was investigated by immersing the adhesive joints (cured/dried) in demineralized water for different durations (one day to 2 months). After a certain immersion time, the specimens were removed from water, and the lap shear strength was immediately measured. To evaluate the durability of the wet adhesive joints, a high-speed “fatigue” test was conducted using the TestProfiler module (Intron 345c, USA). The adhesive joints were immersed in water for 2 months, whereupon a cyclic extension-compression (single-lap shear mode) test was conducted. To do so, the adhesive joints were first extended with high speed rate until 50% of the maximum shear strength of the adhesive (measured for sister samples immersed in water for 2 months) was reached, then compressed with the same speed back to zero force. This cycle was repeated until the adhesive joint failed, and the number of cycles until failure was recorded.

Two sets of experiments are designed to evaluate the water-resistance of chitosan/tannic acid against two commercial adhesives, i.e., Gorilla Glue and SuperGlue.

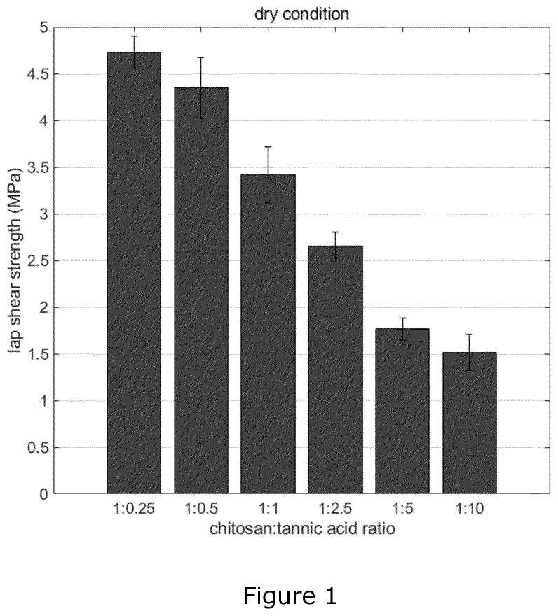

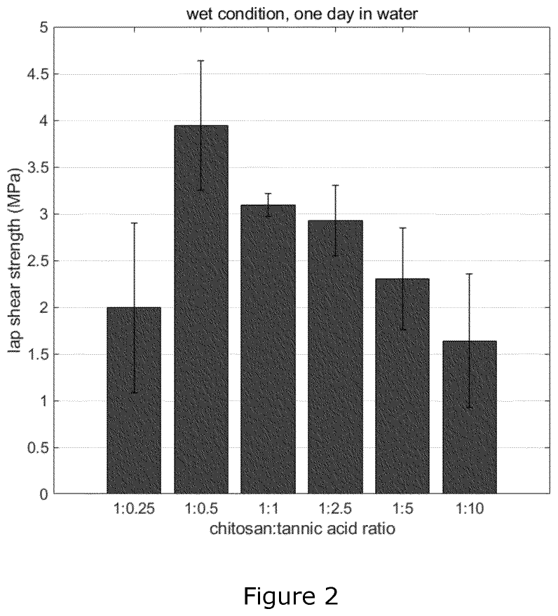

FIG. 1-2 summarize the results of optimizing the mixing ratio of chitosan and tannic acid. A one-day immersion test is conducted on chitosan-tannic acid coacervate adhesives to choose the optimal chitosan:tannic acid ratio with the highest water-resistance (FIG. 2).

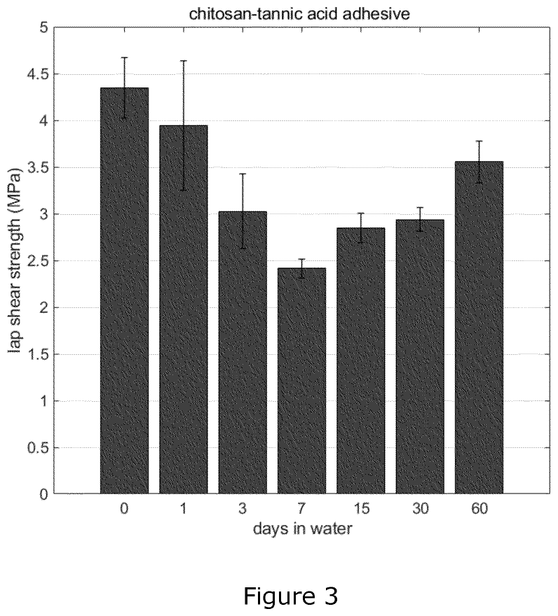

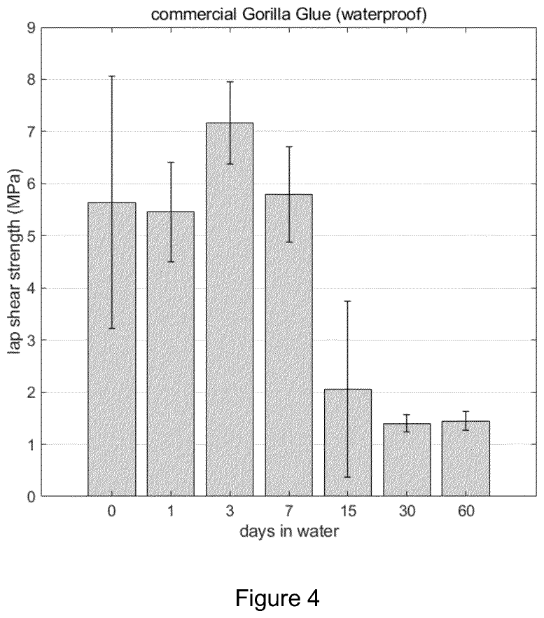

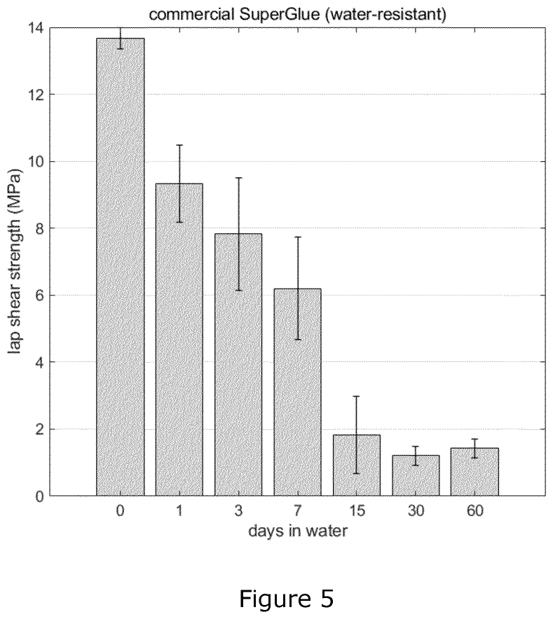

Accordingly, the adhesive with a chitosan:tannic acid ratio of 1:0.5 demonstrated the largest shear strength (˜4 MPa), which was then chosen to be benchmarked against the commercial counterparts in a long water-resistance test. Herein, the adhered specimens were immersed in water for up to 2 months, after which the lap shear strength in wet state was measured (FIG. 3-5).

Regarding the first commercial adhesive (Loctite SuperGlue), a strong dry adhesive strength of ˜ 14 MPa was found. Nevertheless, the adhesive strength significantly drops after immersion in water, showing the weakest water-resistance among the three studied adhesives. The adhesive strength monotonically decreases with immersion time. After 15 days, the shear strength was found to be ˜1.5-2 MPa (˜10% of dry adhesive strength), after which the adhesive strength remained nearly the same. Gorilla Glue demonstrated a superior water-resistance compared to SuperGlue. The dry adhesive showed a shear adhesive strength of ˜5.5 MPa. However, the adhesive strength notably declines as a result of longer immersions, reaching a shear strength of ˜1.5-2 MPa (˜30% of dry adhesive strength) after 30 days, thereafter the adhesive strength remains almost the same.

Interestingly, chitosan:tannic acid adhesive (in a weight ratio of 1:0.5) rendered the most stable adhesive strength even after 2 months of immersion. A decrement in the adhesive strength was observed after 3 days of immersion, where the adhesive strength is reduced to ˜3 MPa (˜60% of dry adhesive strength), which can be attributed to the water penetration within the adhesive and the corresponding plasticization and swelling effects. Nevertheless, longer immersions in water did not produce any weakening of the adhesive properties, and the adhesive strength remained almost the same up to 2 months of immersion. Overall, after 2 months of being in water, chitosan-tannic acid adhesive demonstrated the least relative reduction in its adhesive strength (˜35% reduction) and renders the largest absolute adhesive strength (˜3.5 MPa) among all.

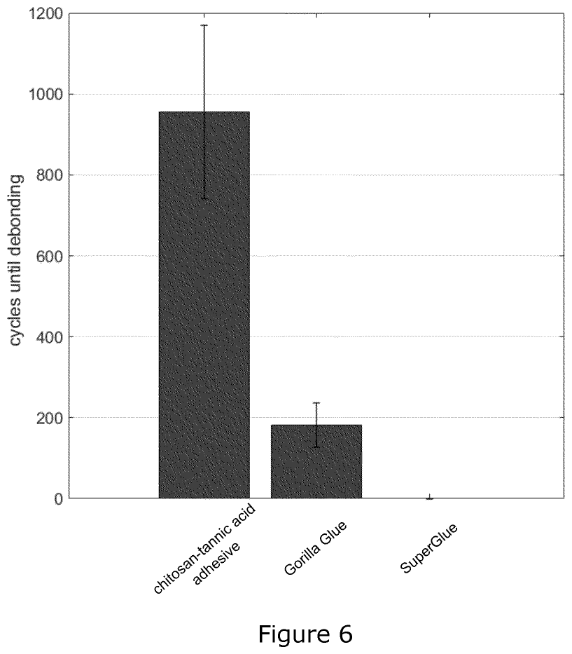

The second experiment (FIG. 6) was more focused on evaluating the durability of the adhesive joints after a long exposure to water. To do this, the adhesive joints were immersed in water for 2 months, whereupon cyclic extension-compression loads were applied to the adhesive joint until the bonding failed. In each case, the adhesive joint is extended in shear mode until reaching 50% of the maximum adhesive strength (when immersed in water for 2 months, see FIG. 3-5). Accordingly, chitosan:tannic acid complex/coacervate adhesive demonstrated an average shear strength of 4 MPa after 2 months of immersion in water, thus the adhesive was exercised by a 0-2 MPa cyclic test (FIG. 6). On the other hand, Gorilla Glue and SuperGlue specimens demonstrated a shear strength of ˜1.5 MPa, thus the samples were exercised by a 0-0.7 MPa cyclic test (FIG. 6). The results confirmed the outstanding durability of chitosan:tannic acid adhesive against the two commercial adhesives (FIG. 6). SuperGlue did not pass this test as most specimens simply failed after less than 10 cycles. Gorilla Glue demonstrated higher durability compared to SuperGlue, i.e., the adhesive joint could withstand an average of 200 cycles before debonding (FIG. 6). This behavior can be assigned to the relatively more flexible nature of the polyurethane foam adhesive that facilitates the deformation of the adhesive joint. Notably, chitosan:tannic acid adhesive required ˜1000 cycles to debond.

Chitosan: tannic acid adhesive demonstrated superb durability, characterized by an average of 1000 cycles required for adhesive failure. It should be noted that the applied load to chitosan:tannic acid adhesive is three times larger than SuperGlue and Gorilla Glue, yet the durability (i.e., number of cycles to failure) is significantly larger compared to the commercial adhesives. This performance may be attributed to the interconnected network of chitosan-tannic acid held together via reversible bonds, e.g., hydrogen bonding, ionic bonding, and hydrophobic bonds, that may break and reform during the cyclic test. Therefore, the applied energy can be effectively dissipated within the adhesive, prolonging the adhesive durability.

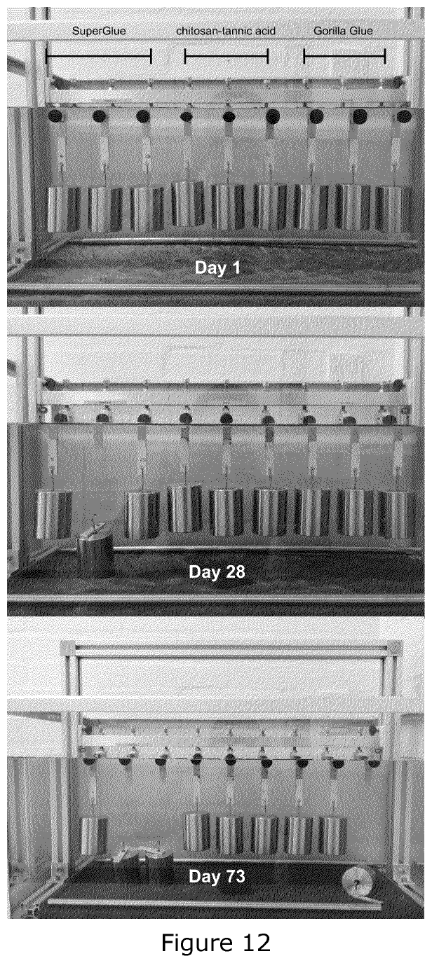

Parallel to testing the lap shear strength of our chitosan-tannic acid adhesive and two commercial adhesives, their durability underwater over extended periods was also investigated. To do so, three specimens for each adhesive were prepared (aluminum substrates, same parameters as used for preparation specimens for lap shear testing). These specimens were clamped onto a rack, a 2-kG hooked weight was hanged onto each and immersed in an aquarium box filled with demineralized water (FIG. 12). In this test, the longer the specimen can hold the weight the more durable it is underwater. Overall, the chitosan:tannic acid adhesive demonstrated great durability underwater. In particular, a typical bio-based adhesive (non-water-resistant) will fail shortly, typically in less than a few hours.

To test other substrates than aluminum, the lap shear strength of the chitosan-tannic acid adhesive was measured on:
Binding aluminum to poly (methyl methacrylate) (Acrylic),
Binding aluminum to poly (carbonate) (PC),
Binding aluminum to steel (Stainless steel),
Binding aluminum to plywood and
Binding plywood to plywood,

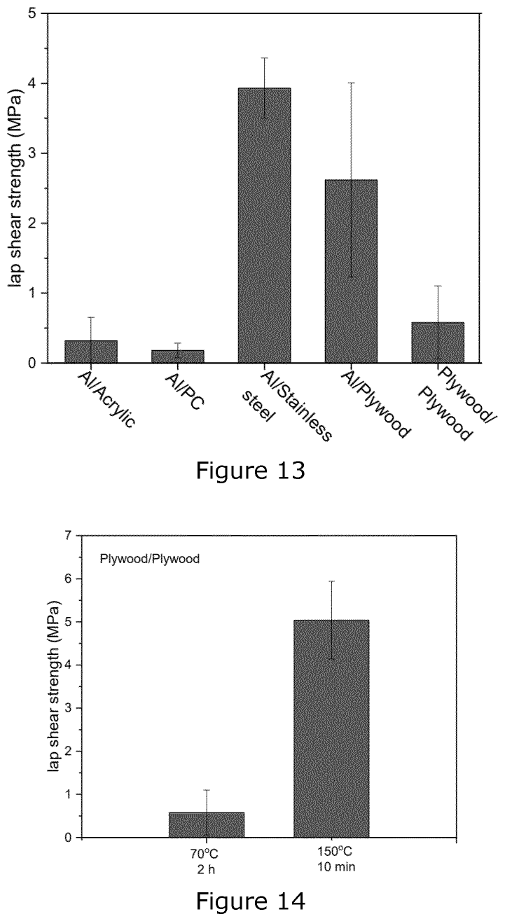

In all cases, the specimens were cured for 2 hrs at 70° C. The specimens were only tested under dry condition. Overall, the adhesive showed a degree of adhesion to all tested material (FIG. 13). Weaker adhesion strength against plastic/polymers is typically expected given the low surface energy/non-reactive nature of these materials. In commercial applications, plastics are generally surface treated (using adhesion primers, plasma, etc.) to improve the adhesion strength.

Furthermore, the effect of curing time and temperature on the lap shear strength of the chitosan-tannic acid adhesive was measured on additional plywood substrates, where the adhesive was cured at either 2 hrs at 70° C. (default condition used for all experiments) or 10 min at 150° C. (new condition) (FIG. 14).

The default curing condition (2 hrs at 70° C.) can be modified depending on the target application, to adjust the properties of the chitosan-tannic acid adhesive. Herein, we chose a typical curing procedure used to test wood adhesives, i.e., higher temperature and shorter. It is shown that the lap shear adhesion strength of the adhesive significantly enhanced simply by increasing the curing temperature (FIG. 14).

### Lyophilization

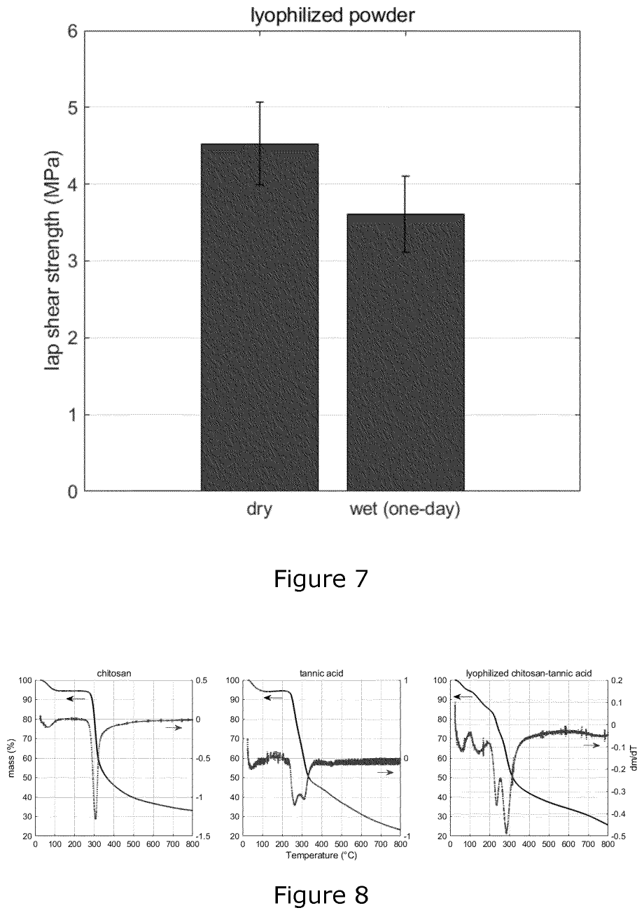

For some purposes, it be useful to keep the adhesive of the invention in a solid form. For that purpose, the adhesive of the present invention can be lyophilized to obtain white powder which can be mixed with water or a buffer solution in a desired ratio to obtain the adhesive of the present invention again. To demonstrate this property, the dried powder was mixed with water in a 1:4 weight ratio, providing a paste-cement-like material that was used to adhere aluminum substrates according to the procedure above. After 2 hrs curing at 70° C., the lap shear strength of this adhesive was then measured dry and wet (one-day immersion), the results of which are provided in FIG. 7. Accordingly, an average dry lap shear strength of ˜4.5 MPa and wet lap shear strength of ˜3.5 MPa was found, consistent with the values in FIG. 3.

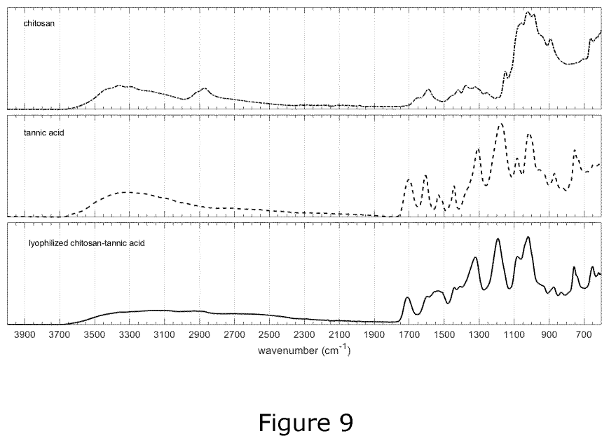

Thermogravimetric analysis (TGA) and FTIR spectra of the white solid (lyophilized chitosan-tannic acid powder) are provided in FIG. 8-9.

TGA was conducted to study the thermal stability of the material (data of pure chitosan and pure tannic acid are provided as reference):
Chitosan
   Below 200° C., 5% mass loss due to water evaporation
   Major decomposition at around 300° C., due to de-polymerization and decomposition of the acetyl and amine groups of chitosan
   ˜33% remained ash at 800° C.
Tannic acid
   Below 200° C., 5% mass loss due to water evaporation
   Two decomposition events below and above 300° C., due to degradation/decarboxylation of the outer aromatic groups of tannic acid
   ˜24% remained ash at 800° C.
Chitosan/tannic acid complex (dried adhesive, dried precipitate)
Below 200° C., 15% mass loss
   First, a water evaporation peak found (5% mass loss),
   Then, between 100-200° C., a new peak (10% mass loss) that was not observed for pure chitosan and tannic acid (can be a minor decomposition).
Two major decomposition peaks at 235 and 285° C.,
˜26% remained ash at 800° C.

### Items

1. An adhesive obtainable by
   mixing chitosan and tannic acid (wt % ratio) in an aqueous solution at the pH value in a range of from 4.5 to 6 preferably at about 5.5,
   centrifuging or filtering the mixture to obtain a polymer-rich and a polymer-poor phase,
   isolating the polymer-rich phase.
2. An adhesive of item 1, characterized by mixing a solution of tannic acid with a solution of chitosan.
3. An adhesive of item 1, characterized by adding tannic acid and to a chitosan solution having a pH value of about 5.5.
4. An adhesive according to any of the preceding items, characterized in that degree of deacetylation of chitosan >92.6%.
5. An adhesive according to any of the preceding items, characterized in that the dry weight ratio of chitosan:tannic acid is in a ratio of from 1:0.1 to 1:10 such as from 1:0.2 to 1:5, from 1:0.25 to 1:5, preferably from 1:0.25 to 1:0.5, or 1:0.1, 1:0.2, 1:0.25, 1:0.3, 1:0.4, 1:0.5, 1:0.6, 1:0.7, 1:0.8, 1:0.9 or 1:1.
6. An adhesive according to any of the preceding items obtainable by further steps of
   lyophilizing the polymer-rich phase to obtain solid material; and
   mixing the so-obtained solid material in water or buffer with a pH-value of about 5.5).
7. An adhesive according to any of the preceding items, characterized by wet lap shear strength of at least 3.5 MPa during a time period of at least 30 days, wherein the Lap shear strength is measured using a Universal Testing System and wherein the adhesive is evenly applied to pre-cut aluminium substrates (50 mm×12 mm), cured in an oven at 70° C. for 1 hour and tested according to a modified ASTM D1002 procedure.
8. An adhesive according to any of the preceding items obtainable by further step of curing the polymer-rich phase at a temperature of from 50 to 90° C. such as at a temperature of from 60 to 80° C., from 65 to 75° C. or about 70° C. for a time period of from 0.5 to 6 hours such as from 0.5 to 4 hours, from 0.5 to 3 hours, from 0.75 to 3 hours, from 0.75 to 2 hours, from 0.75 to 1.5 hours, or about 1 hour.
9. A method for preparing an adhesive as defined in any one of items 1-8, characterized by
   mixing a chitosan solution with a solution of the tannic and adjusting the pH value of the resulting mixture to a pH in a range of from 4.5 to 6 and centrifuging the mixture to obtain a polymer-rich phase and the polymer-poor phase; and isolating the polymer-rich phase.
10. The method of item 9, characterized by adding solid tannic acid into a solution of chitosan and adjusting the pH value to a pH in a range of from 4.5 to 6, such as from 5 to 5.5.
11. A method according to item 9 or 10 further comprising steps of
   lyophilizing the polymer-rich phase to obtain solid material; and
   mixing the so obtained solid material in water or in a buffer with a pH-value of about 5.5.
12. A method according to any of items 9-11 further comprising a step of curing the polymer-rich phase at a temperature of from 50 to 90° C. such as at a temperature of from 60 to 80° C., from 65 to 75° C. or about 70° C. for a time period of from 0.5 to 6 hours such as from 0.5 to 4 hours, from 0.5 to 3 hours, from 0.75 to 3 hours, from 0.75 to 2 hours, from 0.75 to 1.5 hours, or about 1 hour.
13. An adhesive containing cross-linked chitosan and tannic acid, characterized by wet Lap shear strength of at least 3.5 MPa during a time period of at least 30 days, wherein the Lap shear strength is measured using a Universal Testing System.
14. An adhesive according to item 13, wherein the adhesive is as defined in any of items 1-8.
15. A gel consisting of cross-linked chitosan and tannic acid, wherein chitosan and tannic acid is present in the gel in a total concentration of from 2 to 10 wt % such as from 3 to 8 wt %, from 4 to 6 wt % such as about 5 wt %.

1. A method for preparing an adhesive, said method comprising:
mixing chitosan and tannic acid in an aqueous solution, and adjusting the pH value of the resulting mixture to a pH that induces the formation of a polymer-rich phase and a polymer-poor phase to obtain a polymer-rich phase and a polymer-poor phase; and
isolating the polymer-rich phase to obtain said adhesive.

2-16. (canceled)

17. The method for preparing an adhesive according to claim 1, wherein mixing chitosan and tannic acid in an aqueous solution comprises mixing a solution of tannic acid and/or solid tannic acid with a solution of chitosan.

18. The method for preparing an adhesive according to claim 1, wherein the isolating comprises centrifugation, filtration, sedimentation, decantation, or flocculation or any combination thereof.

19. The method according to claim 1, wherein the chitosan in said chitosan solution has degree of deacetylation of >92.6%.

20. The method according to claim 1, wherein the dry weight ratio of chitosan:tannic acid is in a weight ratio from 1:0.1 to 1:10.

21. The method according to claim 1, wherein the adhesive is lyophilized to obtain a solid material.

22. The method according to claim 1, wherein the pH range is from 4.5 to 6.

23. The method according to claim 21, wherein said solid material is mixed with water or a buffer with a pH-value of about 5.5, to obtain an adhesive.

24. The method according to claim 1, further comprising curing the isolated adhesive at a temperature of from 50 to 90° C. for a time period of from 0.5 to 6 hours.

25. The method according to claim 1, further comprising curing the isolated adhesive at a temperature of from 130 to 170° C. for a time period of from 1 to 20 minutes.

26. An adhesive comprising the chitosan and tannic acid obtained in claim 1, wherein the chitosan comprises a cross-link.

27. The adhesive containing cross-linked chitosan and tannic acid according to claim 26, wherein the adhesive has a wet Lap shear strength of at least 3.5 MPa during a time period of at least 30 days as measured using a Universal Testing System.

28. The adhesive containing cross-linked chitosan and tannic acid according to claim 26, wherein the adhesive has a dry Lap shear strength of at least 3.5 MPa on aluminum/stainless steel substrates as measured using a Universal Testing System.

29. The adhesive containing cross-linked chitosan and tannic acid according to claim 26, wherein the adhesive has a dry Lap shear strength of at least 2 MPa on aluminum/plywood substrates as measured using a Universal Testing System.

30. The adhesive containing cross-linked chitosan and tannic acid according to claim 26, wherein the adhesive has a dry Lap shear strength of at least 4.5 MPa on plywood/plywood substrates as measured using a Universal Testing System.

31. The adhesive containing cross-linked chitosan and tannic acid, of claim 26, wherein the adhesive has a wet Lap shear strength of at least 3.5 MPa during a time period of at least 30 days as measured using a Universal Testing System, when said adhesive is evenly applied to pre-cut aluminum substrates (50 mm×12 mm) and cured in an oven at 70° C. for 1 hour and tested according to a modified ASTM D1002 procedure.

32. A gel consisting of the cross-linked chitosan and tannic acid of claim 26, wherein the chitosan and tannic acid are present in the gel in a total concentration of from 2 to 10 wt %.
